(19) United States
(12) Patent Application Publication
(10) Pub. No.: US 2020/0242722 A1
(43) Pub. Date: Jul. 30, 2020

(54) Method for calculating performance indicators for daily fantasy sports

(71) Applicant: Moneyball DFS LLC, Shreveport, LA (US)

(72) Inventor: Keyvan Shahrdar, Shreveport, LA (US)

(21) Appl. No.: 16/000,587

(22) Filed: Jun. 5, 2018

(51) Int. Cl. G06Q 50/34; G07F 17/32

(52) U.S. Cl. CPC G06Q 50/34; G07F 17/3288

(57) ABSTRACT

The current invention proposes a MoneyBall DFS fantasy sports contests using the statistical results of two or more teams, the statistical results of an actual sports team or multiple teams and the statistical results of the participant played the fantasy sports contest and when the participant played the fantasy sports contest as another team. The system allows a participant to select statistics of individual athletes from an actual sports game and of the participant playing in the actual fantasy sports game as an athlete from the actual fantasy sports contest. The present invention discloses the winning outcome determined predominantly by accumulated statistical results of the performance of individuals in multiple real-world sporting or other events (1) comprising of two different and distinct parts (2). The winning outcome is based on part (a) and part (b) as defined in The Unlawful Internet Gambling Enforcement Act of 2006 in (6) (D) (ix) (II).

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention generally relates to improvements in the winning outcome of a fantasy sports game and more particularly to a winning outcome determined in part by a fantasy sports game where a individual athlete is the fantasy sports participant and the actual sporting event is the same fantasy sports game that the fantasy sports participant is playing.

### Description of the Related Art

Fantasy sports have become a way for sports fans from all over the world to interact, communicate, have fun, and compete to achieve on goal, becoming the best manager and player at the game. As well, it creates new friendships, more competition, and new challenges for the opportunity to win cash prizes, awards, and rewards by being the top competitor. Over 30 million people are currently participated in fantasy sports leagues. They play on different sites looking for the best graphic interaction and entertainment.

There are multiple systems that have been proposed in prior art. For instance a method of conducting a fantasy sports game bearing U.S. Pat. No. 6,669,565B2 is issued to Fantasy Sports Inc. The patent discloses a method of conducting a fantasy sports game is provided which includes increasing the points available for winning picks in later rounds and allowing participants to trade teams. The points awarded for picking the winning team may also be based on the Round of the tournament and the “seed” of the winning team. The number of trades available to participants may be decreased in later rounds, or discontinued in the final round. The game is also applicable to Internet based fantasy sports competitions.

A Fantasy sports system and method thereof bearing U.S. Pat. No. 7,699,707B2 is issued to Vhrd LLC. The patent discloses a method of playing a fantasy sport that relates to forming at least two fantasy teams, in which each team is associated with at least one actual player from an actual sport that is played over a multiple-game schedule, selecting a plurality of scoring statistics based on actual scoring statistics associated with the actual sport to measure the performance of the fantasy team, selecting a series corresponding to a portion of an actual schedule of the sport, and determining and evaluating the scoring statistics accrued by the fantasy team during the course of the selected series. The series includes a number of games that is less than the total games in the schedule of the actual sport over a season. A system and an article of manufacture for playing the fantasy sport are also provided.

A Fantasy sports live bearing U.S. Pat. No. 7,351,150B2 is issued to ALL STAR MVP SPORTS Inc. The patent discloses a purpose to change and add to the way fantasy sports games are played by creating an online, virtual live interactive video game that uses fantasy sports statistics as its scoring database system and provides live worldwide communication and competition. The method of playing the online live interactive fantasy video game of the invention comprises a obtaining a subscription to play, selecting a platform from which to play the fantasy game, selecting team members to form a fantasy team, interacting with others playing the fantasy game, and controlling each team member's performance and competing against other fantasy teams. The game includes access to a live fantasy sports television channel to watch games and tournaments, live access to a fantasy sports analyst, and virtual reality software so that the player can become physically involved with the game.

A system and method for providing multi-level fantasy sports contests in fantasy sports contest applications bearing U.S. Pat. No. 7,614,944B1 is issued to Rovi Technologies Corp. The patent discloses a systems and method for providing multi-level fantasy sports contests in a fantasy sports contest application are provided. The fantasy sports contest application may provide multi-level fantasy sports contest in an award league. The fantasy sports contest application may create award leagues of different levels and focus on various geographical units. In some embodiments of the present invention, the fantasy sports contest application may allow a user to enter the same team to compete in one or more leagues. In these embodiments, the same set of rules may apply to all leagues for a particular sport. In some embodiments of the present invention, the fantasy sports contest application may allow the user to advance from lower level leagues to higher level leagues having the same or cooperating sponsors. In some embodiment of the present invention, the fantasy sports contest application may allow a user to enter a team that was previously drafted for one league to compete in another league.

A system and method for conducting a fantasy sports competition bearing U.S. Pat. No. 8,353,772B2 is issued to RPX Corp. The patent embodiments pertain to conducting fantasy sports or other competitions, where users select or draft an entirely new team of professional players each week (or at other suitable time interval). The competition types (including playoffs) include fee based and free. Each fee based competition has a pre-determined entry fee, and prizes are awarded to the winner of that competition each week. The free competitions similarly include weekly prizes and further provide for a grand prize. Within each of the free and fee based types of competitions, users may compete in a “private” competition or a randomly composed “open” competition. Users within the free and fee based competitions may accumulate points that qualify for redemption to obtain prizes. These points are accumulated based upon the statistical performance of the drafted players for each team. The present invention embodiments further provide mechanisms for information sharing and interaction between users.

Another patent disclosing systems and methods for integrating graphic animation technologies in fantasy sports contest applications bearing U.S. Pat. No. 7,872,655B2 is issued to Rovi Technologies Corp. The patent discloses a system and method for integrating graphic animation technologies with fantasy sports contest applications are provided. This invention enables a fantasy sports contest application to depict plays in various sporting events using graphic animation. The fantasy sports contest application may combine graphical representation of real-life elements such as, for example, player facial features, with default elements such as, for example, a generic player body, to create realistic graphic video. The fantasy sports contest application may provide links to animated videos for depicting plays on contest screens in which information associated with the plays may be displayed. The fantasy sports contest application may play the animated video for a user in response to the user selecting such a link. In some embodiment of the present invention, the fantasy sports contest application may also customize animated video based on user-supplied setup information. For example, the fantasy sports contest application may provide play information and other related data to allow a user to generate animated videos using the user's own graphics processing equipment and graphics animation program.

A method and system for a fantasy sports draft game bearing U.S. Pat. No. 8,192,260B2 is issued to Sports Draft Daily LLC. The patent discloses a fantasy sports game provides for a league of fantasy teams, each managed and owned by a fantasy game player. Teams are filled through a player draft of active players followed by ranking each drafted fantasy team utilizing current season player statistics in multiple predefined categories. The rankings in the various categories are totaled to determine team, and thus fantasy game player, rankings. The player statistics utilized are current as of the previous night during regular season play, and as of the end of the season between seasons of play. The draft may be an online web application or utilize live video conferencing.

An on demand fantasy sports systems and methods bearing US patent 2,007,011,3250A1 is issued to TiVo Solutions Inc, Logan James D. The patent discloses a method for enhancing a fantasy sports game with recorded sports broadcasts includes the steps of receiving video programs depicting sports-related events, storing the video programs, associating to a plurality of segments of the video programs attribute data that identifies for a segment of the plurality of segments at least one of a plurality of persons related to a portion of the sports-related events depicted in the segment of the plurality of segments, transmitting to a presentation device for display a player guide containing at least one of the plurality of persons, receiving from a user of the presentation device a video request related to a particular person contained in the player guide, retrieving from the plurality of segments a particular segment associated with attribute data that identifies the particular person, and transmitting the particular segment to the presentation device for display.

A Fantasy sports television programming systems and methods bearing US patent 2,006,018,3547A1 is issued to Mace McMonigle. The patent discloses a system and method that include display systems located at player sites, a server system for generating a television channel comprising real-time live off-shore odds, fantasy betting sports games, standard fantasy sports games, and sports prognosticator predictions, and a communication link for transmitting the television channel to the display systems. The television channel may comprise standard and enhanced fantasy sports games and standard and enhanced fantasy betting sports games with real-time live off-shore odds derived from the one or more off-shore sports books, and sports predictions from sports prognosticators using real-time live off-shore odds from one or more off-shore sports books. Exemplary communication links include cable and satellite providers, telephones, other wireless and wired devices and the Internet. Content may be transmitted by way of cable and satellite providers, telephones, other wired and wireless devices and the Internet. Exemplary display systems include digital non-interactive television systems, digital interactive television systems and web-enabled computer devices. Exemplary programming formats include a linear video channel, a linear interactive television (iTV) channel, an Internet protocol television (IP-TV) channel, and a website channel. The present invention permits interactive fantasy betting on and playing of fantasy betting sports games and fantasy sports games using real-time off-shore betting odds displayed on a television or computer device. The present invention delivers real-time off-shore odds, fantasy betting sports games, fantasy sports games, sports prognosticator predictions, fantasy betting casino games and fantasy casino games for display on television systems and computer devices that implement interactive TV, IP-TV and non-interactive TV.

A Graphical user interface for a fantasy sports application bearing US patent 2,007,002,1165A1 is issued to Protrade Sports Inc, Verizon Media LLC. The patent discloses a graphical user interface (GUI) for a fantasy sports application is provided. The GUI provides intuitive, easy-to-use user interface elements that enable the users to perform an extensive search of athletes based on a combination of one or more extensive and rich search criteria. Other GUIs provide users the ability to include interests in an athlete or multiple athletes in their fantasy teams or portfolios by performing a simple click-and-drag operation.

There are traditional fantasy sports that allows participants to select athletes to form a fantasy team and the winning outcome is determined by the accumulated statistical results of the individual athletes of actual sporting events. However, with MoneyBall DFS fantasy sports game, a participant can select the statistics of a team and the participant can compete as an athlete in the fantasy game to form a fantasy card. The statistics of a team and the statistics of the participant are combined to determine the winning outcome that is determined by the statistical results of the individual athletes of actual sporting events.

There are multiple solutions that have been presented in prior art. However, these solutions are limited and restricted to their conventional systems. There are traditional fantasy sports that allows participants to select athletes to form a fantasy team and the winning outcome is determined by the accumulated statistical results of the individual athletes of actual sporting events. However, with MoneyBall DFS fantasy sports game, a participant can select the statistics of a team and the participant can compete as an athlete in the fantasy game to form a fantasy card. The statistics of a team and the statistics of the participant are combined to determine the winning outcome that is determined by the statistical results of the individual athletes of actual sporting events.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to disclose the winning outcome which is determined predominantly by accumulated statistical results of the performance of individual in multiple real-world sporting or other events comprising of two different and distinct parts.

In accordance with the present invention part (a) of the winning outcome is determined predominantly by accumulated statistical results of the performance of individuals in a single or multiple real-world sporting or another event/s.

According to the present invention, part (b) of the winning outcome is determined predominantly by the statistical result of the timespan of the performance of the same participant that is playing the same fantasy sports game in the same fantasy sports game.

It is also the object of the invention to provide a timespan which is the period of time between two events or during which an event continues. A timespan in the MoneyBall DFS game is when the period of time when the participant starts to form a fantasy card and when the participant ends to form a fantasy card.

Further, according to the present invention, the winning outcome is determined when part (a) and part (b) are combined to comply with The Unlawful Internet Gambling Enforcement Act of 2006 in (6) (D) (ix) (II).

It is further the objective of the invention to provide an advance system that is simple and convenient to use.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to improvements in the winning outcome of a fantasy sports game and more particularly to a winning outcome determined in part by a fantasy sports game where a individual athlete is the fantasy sports participant and the actual sporting event is the same fantasy sports game that the fantasy sports participant is playing.

### The Unlawful Internet Gambling Enforcement Act of 2006 (UIGEA)

The Unlawful Internet Gambling Enforcement Act of 2006—73 FR 69382, Nov. 18, 2008, https://www.gpo.gov/fdsys/pkg/FR-2008-11-18/pdf/E8-27181.pdf. (6) The term ‘bets or wagers’.
(A) means the staking or risking by any person of something of value upon the outcome of a contest of others, a sporting event, or a game predominantly subject to chance, upon an agreement or understanding that the person or another person will receive something of value in the event of a certain outcome;
(B) includes the purchase of a chance or opportunity to win a lottery or other prize (which opportunity to win is predominantly subject to chance)
(C) includes any scheme of a type described in section 3702 of title 28; and
(D) does not include:
(i) any activity governed by the securities laws (as that term is defined in section 3(a)(47) of the Securities Exchange Act of 1934) for the purchase or sale of securities (as that term is defined in section 3(a)(10) of that Act);
(ii) any transaction conducted on or subject to the rules of a registered entity or exempt board of trade under the Commodity Exchange Act;
(iii) any over-the-counter derivative instrument;
(iv) any other transaction that:
(I) is excluded or exempt from regulation under the Commodity Exchange Act; or
(II) is exempt from State gaming or bucket shop laws under section 12(e) of the Commodity Exchange Act or section 28(a) of the Securities Exchange Act of 1934;
   (v) any contract of indemnity or guarantee;
   (vi) any contract for insurance;
   (vii) any deposit or other transaction with an insured depository institution;
   (viii) participation in any game or contest in which participants do not stake or risk anything of value other than:
(i) personal efforts of the participants in playing the game or contest or obtaining access to the Internet; or
(ii) points or credits that the sponsor of the game or contest provides to participants free of charge and that can be used or redeemed only for participation in games or contests offered by the sponsor; or
   (ix) participation in any fantasy or simulation sports game or educational game or contest in which (if the game or contest involves a team or teams) no fantasy or simulation sports team is based on the current membership of an actual team that is a member of an amateur or professional sports organization (as those terms are defined in section 3701 of title 28) and that meets the following conditions:
(I) All prizes and awards offered to winning participants are established and made known to the participants in advance of the game or contest and their value is not determined by the number of participants or the amount of any fees paid by those participants.
(II) All winning outcomes reflect the relative knowledge and skill of the participants and are determined predominantly by accumulated statistical results of the performance of individuals (athletes in the case of sports events) in multiple real-world sporting or other events.
(III) No winning outcome is based:
   (aa) on the score, point-spread, or any performance or performances of any single real-world team or any combination of such teams; or
   (bb) solely on any single performance of an individual athlete in any single real-world sporting or other event.

### MoneyBall DFS and Fantasy Sports Contests

MoneyBall DFS provides online platforms for an individual to enter DFS contest with friends, family, or other fantasy-sports enthusiasts. MoneyBall DFS' contests involve detailed and complex gameplay that integrates innumerable strategic elements that consistently permit more skilled contestants to defeat less skilled contestants.

Daily Fantasy Sports “DES” was a natural and more sophisticated outgrowth of traditional season-long fantasy sports. Like season-long games, DFS gives sports fans the opportunity to use knowledge, skill, and evidence-based analytics to strategically assemble a fantasy team card of statistics and are based on the fantasy points compiled in the contest. Both season-long and DFS games bear exactly the same relationship to real-world sporting events: Fantasy results are based on fantasy points, which are awarded based on statistics compiled by real athletes but are never mere proxies for the binary outcome of real-world sporting events. Indeed, every fantasy contest—whether it is fantasy football, baseball, or scrabble—operates according to this principle. But unlike season-long contests, DFS games last one day.

MoneyBall DFS offers paid, prize-eligible DFS games in twenty-four U.S. states.

MoneyBall DFS offers a variety of contest types (including large-field tournaments, head-to-head and private leagues) in two different sports.

MoneyBall DFS contestants pay an entry fee to enter cash contests, while there is no entry fee to play in free contests. Contest winners receive prizes, the structure of which is always known ahead of time when contestants decide to pay an entry fee and enter a contest. The prizes do not change based on the number of entries.

A MoneyBall contestant's fantasy team card comprises of eleven real-world statistics, the date and time the fantasy team card was created, and the speed in which the contestant created the fantasy team card. The success of the fantasy team card depends on the combined performance of a team in a real-world sporting event, the speed in which the contestant created the fantasy team card, and the date and time the fantasy team card was created.

The strategy required to play MoneyBall DFS successfully is wholly unrelated to correctly predict the ultimate win-loss outcome or margin of victory in any real-world sporting event, such as football or basketball game, as in a traditional sports betting. The results of MoneyBall DFS' fantasy contests are not tethered to the outcomes of those real-world sporting events. Nor do they have anything to do with predicting whether an athlete will achieve a particular in-game achievement, as in a traditional proposition bet. MoneyBall DFS' customers do not place bets on events outside of their control; rather, they pay entry fees to participate in a fantasy contest against other contestants in which they compete by creating a fantasy team card that determines winner and losers of the fantasy contests.

MoneyBall contestants are the actual individuals of the fantasy game in a bona fide contest of skill.

MoneyBall DFS Contestants actually compete against one another to determine who put together the best-performing fantasy team card, and as such, they are the actual contestants in a contest. No one would deny that while football players compete in a game of skill, so too do the general managers of real-world football teams, competing against other real-world general managers in constructing rosters through their strategy, knowledge, and analysis. So too with MoneyBall DFS, where contestants act as their fantasy team's general manager using strategy, knowledge, and analysis to craft their fantasy team card and compete against other fantasy team cards of other MoneyBall DFS contestants. The fantasy competition is the only contest in which MoneyBall DFS contestants pay an entry fee to compete, and in which they are eligible to win a predetermined prize. And MoneyBall DFS contestants profoundly influence the outcome of the fantasy contest by using skill to exercise complete control over their chosen statistical values and the speed in which they complete the sports card.

Accordingly, fantasy sports contests—unlike sports gambling—involve prizes for a contest of skill that is completely distinct from the games being played on the athletic field. Nothing in MoneyBall DFS' gameplay allows a contestant to simply wager on the number of touchdowns Tom Brady throws or the number of baskets LeBron James scores. The fantasy game remains a discrete game unto itself—with distinct rules involving distinct elements applied to distinct contestants—the MoneyBall DFS players who are competing in MoneyBall DFS contests. It is a Contest in its Own Right.

### MoneyBall DFS' Contests Are Complex Games of Skill, Not Gambling.

The evidence is overwhelming that MoneyBall DFS' contests are complex games of skill. In essence, MoneyBall DFS' contestants act as general managers of a fantasy team and compete against other contestants to see who can execute the managerial skill set most effectively, as measured by fantasy points earned. Succeeding as a fantasy general manager requires mastering of broad array of concepts and skills, but at the heart of the contest are three core strategic elements: (1) the statistics for the end of game fantasy team card and the speed in which the contestant creates the fantasy team card, which implicates strategies to determine how fast a contestant can predict the statistical performance of a team; (2) The fantasy-point scoring systems, which affect the relative valuation of the statistics; and (3) the contest rules and prizing eligibility, which affect team selection strategies.

### Core Strategic Element #1: Statistics Prediction for the End of Game Fantasy Team Card

MoneyBall DFS assigns a fantasy team card to the participant. The same fantasy team card applies consistently to all contestants in a contest. MoneyBall DFS contestants must analytically estimate the end of game statistics taking into accounts players suspensions or injuries, weather, opposing teams ranking in offense and defense, previous game history, and if they are playing home or away. Contestants must also expediently research and enter their predicted end of game statistics into the fantasy team card to earn additional points. How soon the contestants join the contest is a component of the fantasy team card. Tiebreakers are determined by the contestant that joined the contest first.

### Core Strategic Element #2: Fantasy Point Scoring System

MoneyBall DFS contests are governed according to unique fantasy point scoring systems that determine how man fantasy points are gained or lost for each applicable real-world statistic. Learning, understanding, and mastering MoneyBall DFS unique scoring system adds another level of strategic decision-making to the MoneyBall DFS General Manager's skill set. Points are earned by predicting the end of game statistics for a real-world team. Additional points are earned by inputting the predictions into a fantasy team card expediently. A tiebreaker is decided by the player who entered the contest first.

### Core Strategic Element #3: Contests Rules Regarding Prize Eligibility

Another MoneyBall DFS contest attribute that drives contest selection strategy is prize structure—who wins and how much. MoneyBall DFS offers a variety of different types of contests, with some contests involving a top-heavier prize structure than others. Again, these differences in contest design create drastically disparate strategic incentives.

Large-field tournaments generally have top-heavy prize structures in which approximately the top 20% of finishers earn prizes, and the clear majority of prizes, by dollar amount, are paid out to the top 1% of finishers. By contrast, in both head-to-head and larger 50/50 contests, a MoneyBall DFS contestant wins the maximum prize merely finishing in the top half of the field.

MoneyBall DFS contestants know that for their contest are not guaranteed to “make”. The contest must “make” with one hundred percent participation in the contest size. The amount of the entry fee, the size of the contest, and the team selected for the game in play are factors that determine if the contest will make.

It is up to the contestant to study current enrollment of MoneyBall DFS and the factors that will induce other participants to consider participating in the contest. MoneyBall DFS unique prize structure strategy adds another level of strategic decision-making to the MoneyBall DFS General Manager's skill set.

### How to Play MoneyBall DFS

### Contest Entry

The Entry-Fee and Prize Pool for a contest will not change once the contest is created. Therefore, each contest has a maximum amount of total entries accepted. Contests that have not reached capacity will be available for entry up until the contest start time.

Guaranteed contests will run (with prizes unchanged) even if they do not reach capacity before the contest start time. Non-guaranteed contests that do not reach capacity by contest start time may be merged with other similar unfilled contests or may be canceled and refunded.

### Scoring and Payouts

Live scoring updates are strictly for the enjoyment of MoneyBall customers. MoneyBall' official scoring validation process begins once the game within the contest is final. This process ensures that MoneyBall scoring matches official stat providers when contest results are finalized and paid out.

Once contests are finalized, a contest status will update to “Completed”, and that contest will move from the “Live Games” section to the “Completed Games” section on the My Contests page.

On occasion, official scorers may issue a stat-correction after games have ended and the official scoring validation process has completed. These corrections are rare but can occur days after a game is played. Therefore, any changes to official scoring that occur after contests have been finalized will not impact those finalized contests. Conversely, if a correction needs to be made after contests are finalized due to a bug with the data feed or the finalization process, while extremely rare, the finalization process (including payment) may be reversed and redone correctly.

Note: The official scoring validation process is solely to ensure that MoneyBall contest results are determined based on official scoring. Delays during this process may occur as a result of data collection or other technical difficulties. MoneyBall will not attempt to make judgments on scoring rulings.

### Contest Results

Contest results will be determined by three separate events. (1) The total points accumulated by each contestant of the predicted end of game statistics entry versus the actual end of game statistics (scoring rules summarized below). (2) The total points earned by each contestant determined by the amount of time the contestant spent creating the game card. (3) The date and time the contestant entered the contest.

Participation in each contest must be made only as specified in the Terms of Use. Failure to comply with these Terms of Use will result in disqualification and, if applicable, prize forfeiture.

### Scoring Explained

Scoring is based on the contestant's ability to predict the statistical outcome of the game vs the actual statistical outcome of the game and how fast the contestant creates the game card. PE=Points Earned, P=Predicted, A=Actual. To calculate the points earned by the contestant, (PE=P/A) the predicted end of game statistics is divided by the actual end of game statistics when the prediction is lower than the actual. The actual end of game statistics is divided by the predicted end of game statistics (PE=A/P) when the actual is lower than the prediction. When there is a zero in the predicted end of game statistics or the actual end of game statistics, a one is added to both the prediction and actual before the points are calculated. The Speed in which the Fantasy Card is created by the user is calculated by the following formula—(Max−Speed)\hat{ }1.21. Max is always=to 300, speed is equal to the difference between the time when the contestant started to create the Fantasy Card and the time when the contestant finished creating the Fantasy Card.

Winner of a contest is based on the contestant/s with the highest point scores. Tiebreakers are determined by the contestant who enters the contest first. The point value for a Tiebreaker is awarded by the difference in the timestamp the contest was created and when the contestant entered the contest in seconds (dT). The formula for points awarded is PE=(604800−DT)\hat{ }0.519.

| | | | Points |
|---|---|---|---|
| | | | earned |
| | Contestant's | | Prediction / |
| | end of | | Actual * 10k |
| | game | Actual end | or Actual / |
| | statistics | of game | Prediction * |
| Part (a) | predictions | statistics. | 10k. |
| Passing First Downs | 13 | 14 | 9285.71429 |
| Rushing First Downs | 9 | 11 | 8181.81818 |
| Total Plays | 58 | 61 | 9508.19672 |
| Total Drives | 13 | 14 | 9285.71429 |
| Passing Yards | 265 | 365 | 7260.27397 |
| Completions | 19 | 21 | 9047.61905 |
| Passing Attempts | 29 | 33 | 8787.87879 |
| Rushing Yards | 98 | 103 | 9514.56311 |
| Interceptions Thrown | 1 | 2 | 5000 |
| Sacks Allowed | 1 | 3 | 3333.33333 |
| Final Score | 24 | 25 | 9600 |
| | | Points: | 88805.11173 |
| | | | Points |
| | | | Earned |
| | | | (Max - |
| | Time in | Max | Speed)\hat{ } |
| Part (b) | seconds | Seconds | 1.21 |
| Speed of participant playing | 16 | 300 | 930.06904 |
| fantasy sports game | | | |
| | | Total | 89735.18077 |
| | | Points: | |
| | | Contestant | |
| | Contest | Create | |
| | Create Time | Time | Points |
| | Stamp | Stamp | Earned |
| Tie Breaker | 10/10/18 | 10/12/18 | (604800- |
| | 14:00:00 | 13:45:69 | dT) \hat{ } .519 |

### Canceled, Postponed, and Rescheduled Games

If a game is canceled, postponed, or a game is rescheduled to a time outside of the original Scoring Period, MoneyBall will cancel and refund all contests.

### Suspended or Shortened Games

MoneyBall uses official sports statistics and only includes statistics from games the sports deems to be official. If the sport declares a game “suspended” then the statistics generated before the game is suspended will count in the contest containing the said game. Any statistics generated on a later date when the game resumes will not be included.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method for calculating performance indicator for daily fantasy sports comprising:
a fantasy sports contest allowing a participant to select statistics from different teams to form a fantasy card;
using the statistical results of two or more teams;
using the statistical results of an actual sports team or multiple teams in an actual game or multiple games and the statistical results of the participant in the same fantasy sports contest and when the participant played the fantasy sports contest as another game;

2. A MoneyBall DFS fantasy sports contest allowing a participant to select statistics of individual athletes from an actual sports game and also allowing a participant to select statistics of the participant playing in the actual fantasy sports game as an athlete from the actual fantasy sports contest.

3. A system for determining winning outcome predominantly by accumulated statistical results of the performance of individual in multiple real-world sporting or other events (1) comprising of:
part (a) of the winning outcome determined predominantly by accumulated statistical results of the performance of individuals in a single or multiple real-world sporting or another event/s;
part (b) of the winning outcome is determined predominantly by the statistical result of the performance of the same participant that is playing the fantasy sports contest in the same fantasy sports contest as an individual in a single real-world event.
winning outcome based on part (a) and part (b) as defined in The Unlawful Internet Gambling Enforcement Act of 2006 in (6) (D) (ix) (II).
